(19) United States
(12) Patent Application Publication
(10) Pub. No.: US 2026/0204143 A1
(43) Pub. Date: Jul. 16, 2026

(54) SYSTEMS AND METHODS FOR PROVIDING AN INSTANT FEATURE IN BINGO ELECTRONIC GAMING

(71) Applicant: Aristocrat Technologies, Inc., Las Vegas, NV (US)

(72) Inventors: Jose Antonio Uberuaga, Reno, NV (US); Daniel Marston, Reno, NV (US); Donald Rollo, III, Dacula, GA (US); Ryan North, Broken Arrow, OK (US)

(21) Appl. No.: 19/441,569

(22) Filed: Jan. 6, 2026

Related U.S. Application Data
(60) Provisional application No. 63/744,023, filed on Jan. 10, 2025.

(51) Int. Cl. G07F 17/32

(52) U.S. Cl. CPC G07F 17/329; G07F 17/3225

(57) ABSTRACT

An electronic gaming system including a first electronic gaming device and a second electronic gaming device is described. The electronic gaming system is configured to transmit a first portion of a ball call to the first electronic gaming device and the second electronic gaming device wherein the first electronic gaming device is configured to analyze the first portion of the ball call against a first bingo card to provide an output for a base play and transmit a second portion of the ball call to the second electronic gaming device wherein the second electronic gaming device is configured to analyze the first portion of the ball call and the second portion of the ball call against a second bingo card to provide an output for an instant feature play and cause display of an animation between receiving the first portion and the second portion.

### CROSS REFERENCE TO RELATED APPLICATION

This application claims the benefit of priority to U.S. Provisional Patent Application No. 63/744,023, filed January 10, 2025, which is hereby incorporated by reference herein in its entirety.

### TECHNICAL FIELD

The field of disclosure relates generally to electronic gaming, and more specifically, to systems and methods for providing an instant feature in bingo electronic gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is described. The electronic gaming system includes a first electronic gaming device configured to provide a base play of a base mode of an electronic game based upon a first input received at the first electronic gaming device and a second electronic gaming device configured to provide an instant feature play of a feature mode of the electronic game based upon a second input received at the second electronic gaming device. The electronic gaming system also includes at least one memory with instructions stored thereon and at least one processor in communication with the at least one memory. The instructions, when executed by the at least one processor, cause the at least one processor to transmit a first portion of a ball call to the first electronic gaming device and the second electronic gaming device wherein the first electronic gaming device is configured to analyze the first portion of the ball call against a first bingo card to provide an output for the base play and transmit a second portion of the ball call to the second electronic gaming device wherein the second electronic gaming device is configured to analyze the first portion of the ball call and the second portion of the ball call against a second bingo card to provide an output for the instant feature play and wherein the second electronic gaming device is configured to cause display of an animation between receiving the first portion of the ball call and the second portion of the ball call.

In another aspect, at least one non-transitory computer-readable storage medium with instructions stored thereon is described. The instructions, in response to execution by at least one processor, cause the at least one processor to receive a first input from a first electronic gaming device, the first input indicating that a base play of a base mode of an electronic game has been initiated at the first electronic gaming device, and receive a second input from a second electronic gaming device, the second input indicating that an instant feature play of a feature mode of the electronic game has been initiated at the second electronic gaming device. The instructions also cause the at least one processor to transmit a first portion of a ball call to the first electronic gaming device and the second electronic gaming device wherein the first electronic gaming device is configured to analyze the first portion of the ball call against a first bingo card to provide an output for the base play and transmit a second portion of the ball call to the second electronic gaming device wherein the second electronic gaming device is configured to analyze the first portion of the ball call and the second portion of the ball call against a second bingo card to provide an output for the instant feature play and wherein the second electronic gaming device is configured to cause display of an animation between receiving the first portion of the ball call and the second portion of the ball call.

In another aspect, a method of electronic gaming is described. The method is implemented by at least one processor in communication with at least one memory. The method includes receiving a first input from a first electronic gaming device, the first input indicating that a base play of a base mode of an electronic game has been initiated at the first electronic gaming device, and receiving a second input from a second electronic gaming device, the second input indicating that an instant feature play of a feature mode of the electronic game has been initiated at the second electronic gaming device. The method also includes transmitting a first portion of a ball call to the first electronic gaming device and the second electronic gaming device wherein the first electronic gaming device is configured to analyze the first portion of the ball call against a first bingo card to provide an output for the base play and transmitting a second portion of the ball call to the second electronic gaming device wherein the second electronic gaming device is configured to analyze the first portion of the ball call and the second portion of the ball call against a second bingo card to provide an output for the instant feature play and wherein the second electronic gaming device is configured to cause display of an animation between receiving the first portion of the ball call and the second portion of the ball call.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example screenshot and/or interface of a base bingo game including an instant feature that may be provided, as described herein.

FIG. 5A illustrates an example screenshot and/or interface for selecting a number of instant features, as described herein.

FIG. 5B illustrates another example screenshot and/or interface for selecting a number of instant features, as described herein.

FIG. 6 illustrates another example screenshot and/or interface for selecting a number of instant features, as described herein.

FIG. 7 illustrates an example screenshot and/or interface for providing an instant feature, as described herein.

FIG. 8 illustrates an example screenshot and/or interface demonstrating features provided from the screenshot and/or interface shown in FIG. 7.

FIG. 9 illustrates another example screenshot and/or interface demonstrating features provided from the screenshot and/or interface shown in FIG. 7.

FIG. 10 illustrates an example screenshot and/or interface of an example feature bingo game before the instant features shown in FIG. 9 have been provided.

FIG. 11 illustrates an example screenshot and/or interface of the example feature bingo game shown in FIG. 10 after an instant feature shown in FIG. 9 has been provided.

FIG. 12 illustrates an example screenshot and/or interface of the example feature bingo game shown in FIG. 10 after another instant feature shown in FIG. 9 has been provided.

FIG. 13 illustrates an example screenshot and/or interface of the example feature bingo game shown in FIG. 10 after another instant feature shown in FIG. 9 has been provided.

FIG. 14 illustrates an example screenshot and/or interface of the example feature bingo game shown in FIG. 10 after all of the instant features shown in FIG. 9 have been provided.

FIG. 15 illustrates an example method for bingo electronic gaming with one or more instant features, in accordance with the present disclosure.

FIG. 16 illustrates another example method for bingo electronic gaming with one or more instant features, in accordance with the present disclosure.

### DETAILED DESCRIPTION

Described herein are systems and methods for providing an instant feature in bingo electronic gaming. As an example, an instant bonus feature may be provided that allows players to either continue with base bingo gameplay (e.g., a base game) or, at any point, place a wager to directly access a bonus feature, bypassing the base game. To achieve providing the instant bonus feature, an increased number of bingo balls may be utilized in each ball call. For instance, typical bingo games may use 40 balls in a ball call. To provide the instant bonus feature described herein, an increased number of balls, such as 47 balls or 52 balls, may be used for ball calls when the instant bonus feature is provided in order to ensure that at least two daubs on the bingo card (e.g., in the “B” and “I” columns) and a guaranteed winning pattern are provided (e.g., triggering the bonus feature).

During a base bingo game, an instant feature button (e.g., physical button or virtual button) is active/displayed. A feature may be provided randomly based upon play of the base bingo game. However, when the player selects the instant feature button, an instant feature scene is displayed that allows the player to buy/select a feature bingo game instantly (e.g., not triggered from the base bingo game). For example, the instant feature scene may include bet multipliers available for the player to select, dynamic wagers that update when changing bet multipliers, and specific wording and/or animations for each feature that may be selected.

When an instant feature is selected the player may be presented with a random number of instant features. For example, three instant features may correspond to three different colored coins/themes in a feature bingo game wherein each colored coin is associated with a different instant feature. A player may select at least one, at least two, or all three instant features. In some embodiments, only at least one feature may be available for selection. In some embodiments, the player may select to buy the instant feature bingo game and a random selection (e.g., based on an RNG output) of instant features may be provided in the instant feature bingo game.

In the example embodiment, an instant feature is a feature game with at least one game enhancement applied therein. For example, a feature game may be a reel game wherein symbols displayed are each associated with an output amount (e.g., the symbols displayed at reel positions are numbers associated with output amounts). In the example embodiment the instant features (e.g., associated with different colored coins) may include a large output amount/feature game award, a multiplier symbol causing all other displayed output amounts to be multiplied, and a symbol worth the sum of all other symbols displayed on the reels. Further, in the example embodiment, certain features may be applied in a determined/predetermined order (e.g., according to a facade, in an order that results in the highest outcome/output amount, etc.). For example, if two features are presented (e.g., two coins are displayed) – the feature associated with causing all displayed output amounts to be multiplied and the feature associated with a symbol worth the sum of all other symbols displayed on the reels – the multiplication may occur before the presentation of the sum of all other symbols displayed is presented.

In an example embodiment, an electronic gaming system is described. The electronic gaming system includes a first electronic gaming device configured to provide a base play of a base mode of an electronic game based upon a first input received at the first electronic gaming device and a second electronic gaming device configured to provide an instant feature play of a feature mode of the electronic game based upon a second input received at the second electronic gaming device. The electronic gaming system also includes at least one memory with instructions stored thereon and at least one processor in communication with the at least one memory. The instructions, when executed by the at least one processor, cause the at least one processor to transmit a first portion of a ball call (e.g., the first forty bingo balls) to the first electronic gaming device and the second electronic gaming device wherein the first electronic gaming device is configured to analyze the first portion of the ball call against a first bingo card to provide an output for the base play and transmit a second portion of the ball call (e.g., the next twelve bingo balls) to the second electronic gaming device wherein the second electronic gaming device is configured to analyze the first portion of the ball call and the second portion of the ball call (e.g., fifty-two balls total) against a second bingo card to provide an output for the instant feature play and wherein the second electronic gaming device is configured to cause display of an animation between receiving the first portion of the ball call and the second portion of the ball call (e.g., during a lag period when the second electronic gaming device waits for the additional twelve bingo balls for the instant feature game).

In some embodiments, the first portion includes a first number of balls of the ball call.In some embodiments, the first portion and the second portion include a total of a second number of balls of the ball call, the second number being greater than the first number, and the second number of balls including the first number of balls. In some embodiments, the second number of balls is configured to be associated with an outcome that guarantees that the feature mode will be entered at the second electronic gaming device instead of the base mode.

In some embodiments, the first electronic gaming device is configured to analyze the first portion of the ball call against the first bingo card and a first set of paytables. In some embodiments, the second electronic gaming device is configured to analyze the first portion of the ball call and the second portion of the ball call against the second bingo card and a second set of paytables. In some embodiments, the first set of paytables includes a first set of bingo patterns and the second set of paytables includes a second set of bingo patterns.

In some embodiments, the instructions further cause the at least one processor to transmit the second portion of the ball call to the second electronic gaming device and not to the first electronic gaming device.

In some embodiments, the instructions further cause the at least one processor to transmit the first portion of the ball call and the second portion of the ball call to a third electronic gaming device configured to provide another instant feature play of the feature mode of the electronic game based upon a third input received at the third electronic gaming device.

In another example embodiment, an electronic gaming system including at least one memory with instructions stored thereon and at least one processor in communication with the at least one memory is described. The instructions, when executed by the at least one processor, cause the at least one processor to receive a first input from a first electronic gaming device, the first input being associated with a base play of a base mode of an electronic game at the first electronic gaming device, and receive a second input from a second electronic gaming device, the second input being associated with an instant feature play of a feature mode of the electronic game at the second electronic gaming device. The instructions also cause the at least one processor to generate a ball call for the electronic game. The instructions further cause the at least one processor to transmit a first portion of the ball call (e.g., forty balls for the base game) to the first electronic gaming device based upon the first input being associated with the base play and transmit a second portion of the ball call (e.g., fifty-two balls to guarantee that the instant feature game is triggered because the instant feature was selected) to the second electronic gaming device based upon the second input being associated with the instant feature play.

In some embodiments, the first portion of the ball call includes forty balls. In some embodiments, the second portion of the ball call includes fifty-two balls.

In some embodiments, the second input is transmitted from the second electronic gaming device based upon a player selecting to trigger the instant feature play at the second electronic gaming device. In some embodiments, the second electronic gaming device bypasses play of the base mode and enters the feature mode upon the player selecting to trigger the instant feature play.

In some embodiments, the first electronic gaming device analyzes the first portion of the ball call against a first bingo card to determine an outcome for the base play and the second electronic gaming device analyzes the second portion of the ball call against a second bingo card to determine an outcome for the instant feature play. In some embodiments, the first electronic gaming device causes the feature mode to be entered based upon analyzing the first portion of the ball call against the first bingo card.

In some embodiments, different paytables are utilized for the base game and the feature game. For instance, a first set of bingo pattern pays may be analyzed with respect to a ball call and a bingo card for the base game, and a second set of bingo pattern pays may be analyzed with respect to a ball call and a bingo card for the feature game.

In some embodiments, the instructions further cause the at least one processor to determine that the second input is associated with the feature mode based upon the second input including a flag indicating that the instant feature play of the feature mode has been selected at the second electronic gaming device. In other words, the second electronic gaming device may flag in a message to a bingo server that the instant feature has been selected (e.g., notifying the bingo server that additional balls, such as the second portion of the ball call as opposed to the first portion of the ball call described above, need to be sent to the second electronic gaming device).

In the example embodiment, the electronic game described herein is a Class II bingo game presented on a gaming device. A bingo card and a bingo number listing may be displayed. For instance, a bingo card may include a matrix of bingo cells (e.g., squares). In some examples, the matrix may be a 5 x 5 matrix of 25 total cells. In some examples, the bingo card may have a matrix of a different size (e.g., 3 x 3, 4 x 4, 4 x 5, 4 x 6, 6 x 6, 7 x 7, 3 x 8, 10 x 10, etc.). In some examples, the matrix may be larger or smaller.

In some examples, the bingo game may be a networked game that involves two or more networked devices, such as gaming devices 104A-104X. For example, many electronic bingo games may be required, by state gaming regulations, to include at least two players. As a result, in these circumstances, a bingo game can only occur if two or more players have placed wagers and received a bingo card to be used to determine a game outcome against a common ball call. A ball call may be initiated once at least two players have joined an electronic bingo game (e.g., a networked electronic bingo game), and each player’s bingo card (or cards) are compared to the same ball call, even where the players are physically separated, such as in different parts of a casino or even in different casinos/external locations.

In conventional bingo games, different gaming devices receive the same number of balls in a ball call, such as a total number of balls in the ball call. Some conventional gaming devices may not utilize the entire ball call even though they receive the entirety of the ball call. In other words, certain gaming devices may need more or less balls of a ball call than other devices. Computer resources are wasted when gaming devices receive more balls of a ball call than are needed and additional technical problems arise when gaming devices receive less of a ball call than is needed to provide a game outcome.

Technical problems addressed by the present disclosure include: i) wasted computer resources based upon gaming devices receiving more or less of a ball than is desired by the gaming devices; ii) lack of computer efficiency in processing portions of ball calls that are not needed to provide game outcomes; and iii) inability of gaming devices to provide a transition while waiting for a number of balls in a ball call needed to provide a game outcome.

Technical solutions provided by the present disclosure include: i) saving computer resources by sending only needed portions of ball calls to gaming devices based upon inputs received from the gaming devices (e.g., less balls for base game play, more balls for instant feature play); ii) increased computer efficiency by gaming devices processing only the portions of ball calls needed to provide an outcome at the gaming devices based upon whether the gaming devices are providing base game play or instant feature play; and iii) ability to provide a transition (e.g., an animation) while a gaming device has received some of a ball call (e.g., the first forty balls) but not enough of a ball call to provide an instant feature outcome (e.g., fifty-two total balls).

Various technical solutions are described herein in order to provide an instant feature in Class II games while ensuring that at least two players are participating. For instance, a base game and an instant feature game may utilize different portions of the same ball call. As an example, forty balls from a ball call may be utilized for the base game and fifty-two balls from the ball call may be utilized for the instant feature game. Thus, at least two players are participating in the overall bingo game associated with the ball call – but a player selecting the instant feature game does not have to wait for another player (e.g., at another device) to also select the instant feature game.

A central determination gaming system server may manage (and/or host) the bingo game, such as by generating bingo cards (or cards, as above) and/or bingo number listings. In some examples, a bingo card (and/or information on which the bingo card is based), and/or the bingo number listing may be generated using an RNG (e.g., RNG 318). In some examples, the bingo card may be randomly selected from a set of bingo cards or a player may select their own bingo card (e.g., via a user interface), such as from a set of randomly generated bingo cards, for example.

In operation, a player and/or gaming device may be provided with a respective bingo card, such as by central determination gaming system server 106. For example, a player may be provided a new bingo card each time a "Spin" or "Play" button is pressed by the player (e.g., via a user interface), provided the player has made a wager/input. In some examples, more than one bingo card may be generated in response to a wager. A bingo number listing (e.g., “ball call”) may be randomly generated, such as by central determination gaming system server 106. A bingo card may be compared to the bingo number listing, and the numbered cells on the bingo card that match numbers in the bingo number listing may be marked or "daubed" on the bingo card. Finally, the marked or daubed bingo card may be evaluated against a paytable of winning bingo patterns.

The bingo number listing may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in the bingo number listing. Other game-ending patterns are also possible. When the game-ending pattern is awarded, the bingo number listing is reset, for all players participating in the bingo game and the process repeats. In some examples, a single play of the bingo game includes a wager, a bingo card, a bingo number listing, a matching of the numbers called with those on a bingo card, a determination of a bingo game outcome, and a presentation of an associated award, if any.

A bingo game outcome may be determined by comparing one or more patterns of marked (and/or “daubed) cells of a bingo card with a paytable of winning bingo patterns. If the bingo card does not include a pattern that matches a pattern in the paytable of winning patterns, then a losing bingo outcome is determined, and no award may be provided to the player. If the bingo card does include a pattern that matches a pattern in the paytable of winning patterns, then a winning bingo outcome is determined, and a reward may be provided to the player.

Different winning patterns may be associated with different awards. The award for a winning main bingo game outcome may be based on an amount wagered, an associated main bingo game paytable, an associated set of rules for the main bingo game, a probability (and/or likelihood) of achieving a particular bingo pattern/combination, an amount of bingo numbers needed to achieve the particular bingo pattern/combination, and/or other considerations. In some examples, the player/player account may be awarded for multiple patterns (e.g., all winning patterns) that are matched when the bingo card is evaluated against the paytable of winning patterns. In some examples, the player may be awarded for only the highest priority pattern (e.g., the highest paying winning pattern) that is matched. In some examples, during play of a Class II game, a player is provided or selects a single bingo card for multiple plays of the bingo game, with a new bingo number listing generated for each play of the bingo game. Other methods of play of a Class II bingo game, Class III games, and/or other games are also envisioned and are within the scope of this disclosure.

The bingo game outcome may be presented to the player via a spinning reel game simulation. One or more combinations of symbols in a matrix of symbols may be associated with a reel game outcome that is equal to at least a portion of the main bingo game outcome. For example, a winning bingo game outcome may be displayed as a winning combination on reels. Similarly, a losing bingo game outcome may be displayed as a losing combination on reels. Different outcomes of the bingo game may be displayed as different outcomes in the spinning reel game. Thus, the bingo game outcome is presented to the player at least in part as a particular reel spin outcome of reels.

In the example embodiment, winning outcomes may be displayed as a combination of game outcomes. For example, a total bingo game outcome may be determined, followed by determination of a script of base game display patterns/sequences, bonus game display patterns/sequences, and/or feature game display patterns/sequences that, in total, correspond to the determined game outcome (e.g., sequential display of the patterns/sequences of the script results in the desired game outcome being displayed/provided – in some embodiments, patterns/sequences of the script may be arranged/organized in an order from a lowest value to a highest value).

In some examples, progressively increasing outputs may be applied to a Class II game as described herein. Game outputs (e.g., credit outputs) may be presented/paid from lowest to highest across a plurality of spins. A number of spins may be determined based upon an amount of a bingo game win or a number of bingo pattern wins, as examples. Sequential display of display patterns/sequences may be controlled until display/communication of a determined number of bingo pattern amounts has been achieved.

In the example embodiment, a game outcome is randomly determined (e.g., by comparing a ball call to a bingo card, by use of an RNG, etc.). A lookup is then performed (e.g., by a game controller and/or based upon an RNG output) in a lookup table (e.g., 322A-N) to determine how to present the total game outcome (e.g., which script/sequence of outcomes to display). As noted herein, using a predetermined number of balls (e.g., fifty-two) may cause the instant feature game to be provided. Accordingly, when the instant feature game is selected, as described herein, the predetermined number of balls may be utilized (e.g., as opposed to a lesser number of balls used for the base game) in any of the ways described herein.

In some embodiments, a random determination may be made to determine which fractions of the total game outcome should be presented by each possible game (e.g., base game, bonus game, etc.). For example, an RNG (e.g., RNG 318 and/or 319A-N) and a data structure and/or lookup table (e.g., 322A-N) may be utilized in order to make the determination of how the total game outcome should be split up amongst different game outcomes. In the example of a 100-credit outcome, the lookup table may include any number of fractions/portions/splits between a base game and/or a bonus game that sum up to 100 credits. In this example, upon the random determination of how the total game outcome will be split amongst different games (e.g., 30-70, 40-60, etc.), another random determination may be made (e.g., based upon the same or a different lookup table) to determine how to display the respective fractions/portions.

For example, if the determined split is a 30-70 split between a base game and a bonus game, there are a plurality of ways to display/communicate a 30-credit base outcome and a 70-credit bonus outcome. Accordingly, one or more next random determinations may be made, based upon the same or a different lookup table, to determine, continuing the example above, which base display sequence (e.g., sequence of spins and displayed symbol outcomes) to use to communicate a 30-credit base outcome and which bonus display sequence (e.g., sequence of spins and displayed symbol outcomes) to use to communicate a 70-credit feature outcome.

For example, the lookup table may be configured as a data structure and/or model such that, based upon an inputted/determined total game outcome amount, a script of which display sequence(s) to use to communicate the game outcome amount (e.g., to a player) may be determined. In some embodiments, an RNG output may be utilized to determine which script to use to communicate a particular game outcome amount. In other words, a total game outcome amount may be determined. Based upon the total game outcome amount, the lookup table can be searched for a set of scripts that correspond to that particular game outcome amount (e.g., the set of scripts may include spins/rounds of a base game, feature game, and/or bonus game, etc.). Then, an RNG output may be utilized to randomly determine which script of the set of scripts associated with the particular game outcome amount to utilize to communicate/convey the game outcome amount.

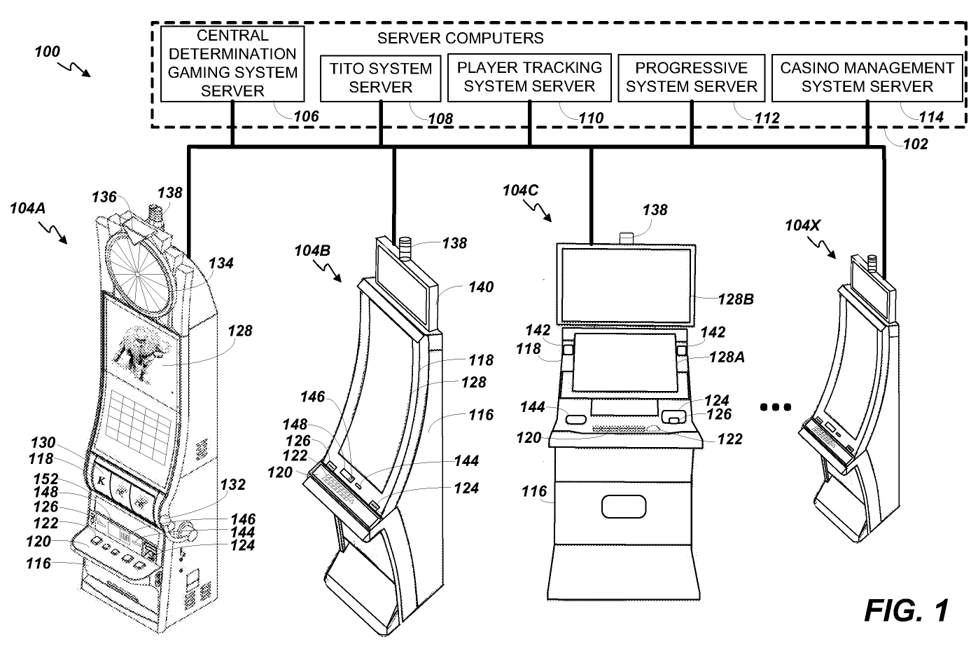

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL^{TM} model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

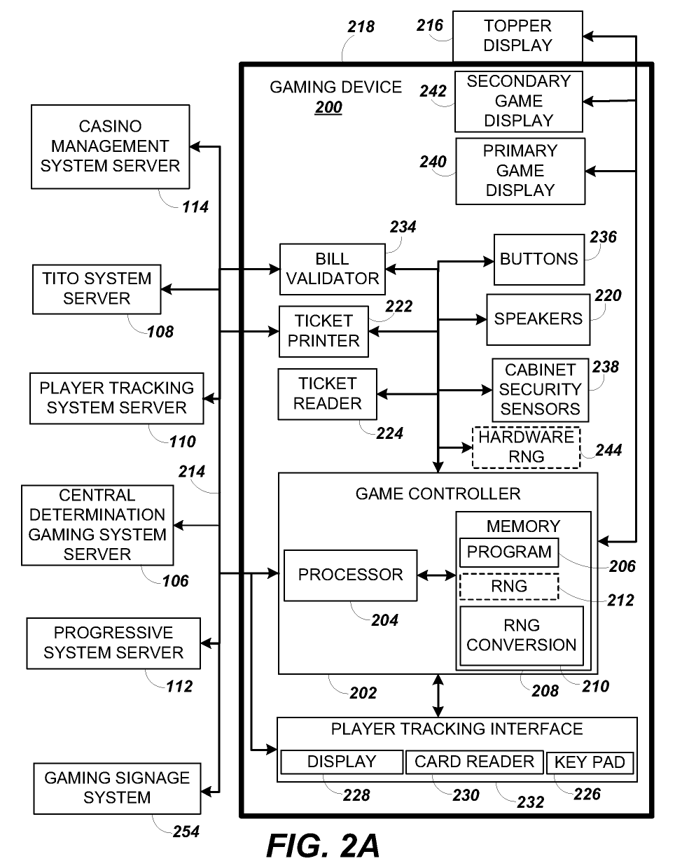

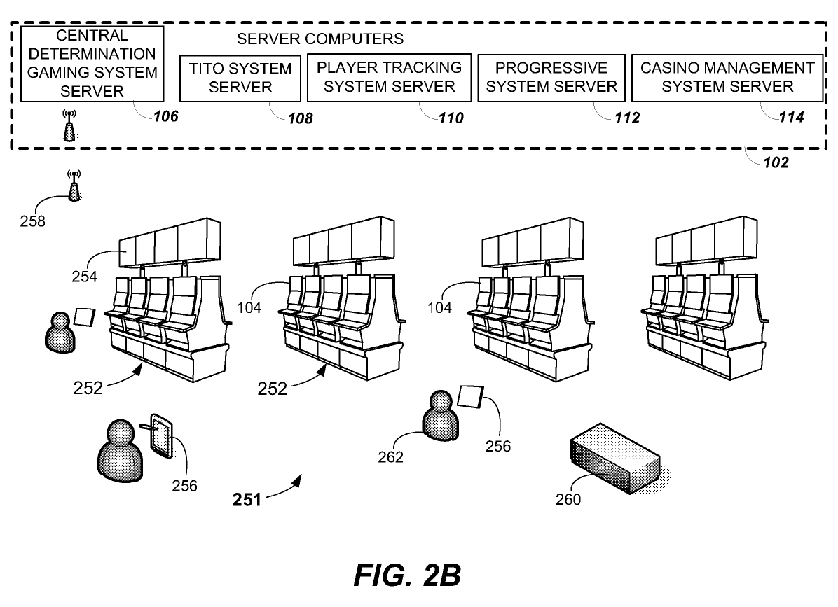

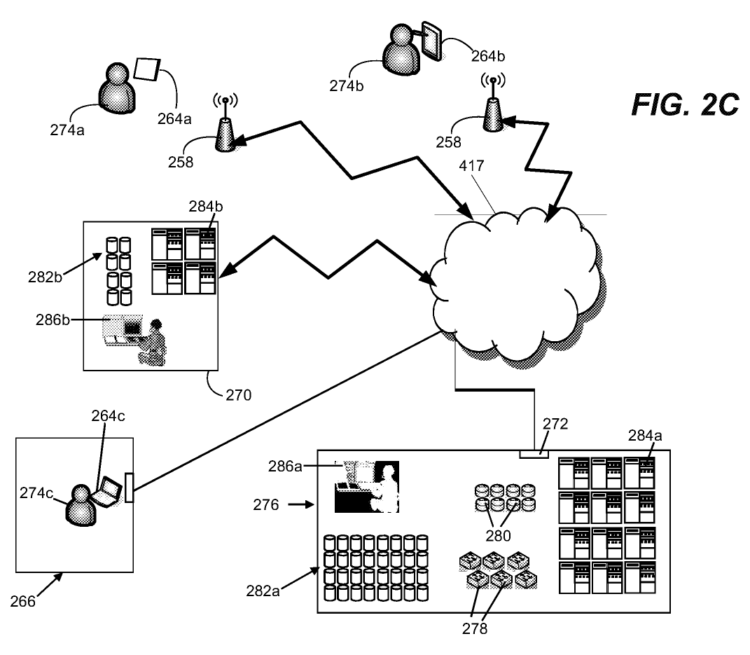

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix^{TM} model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

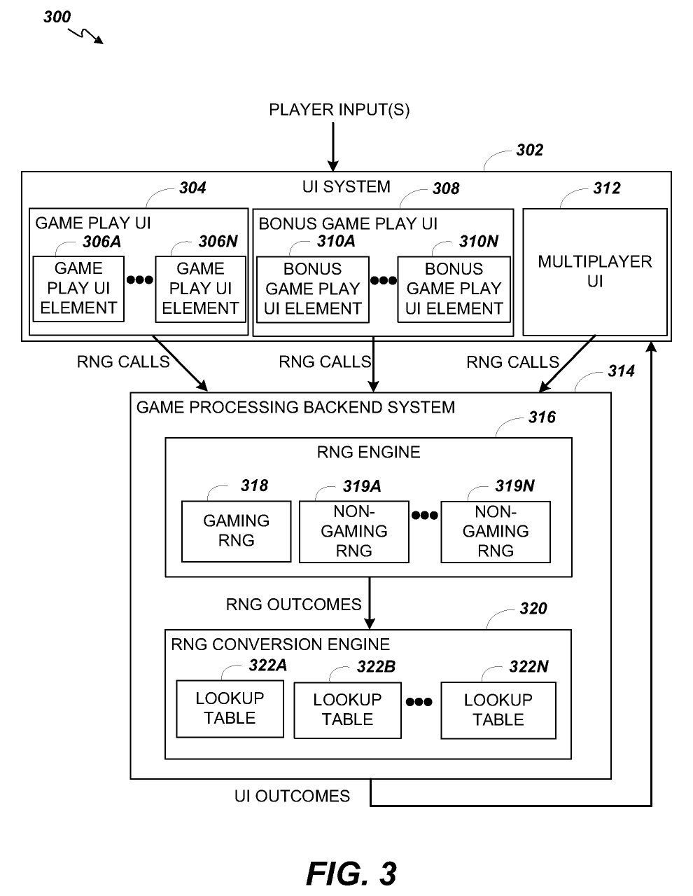

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

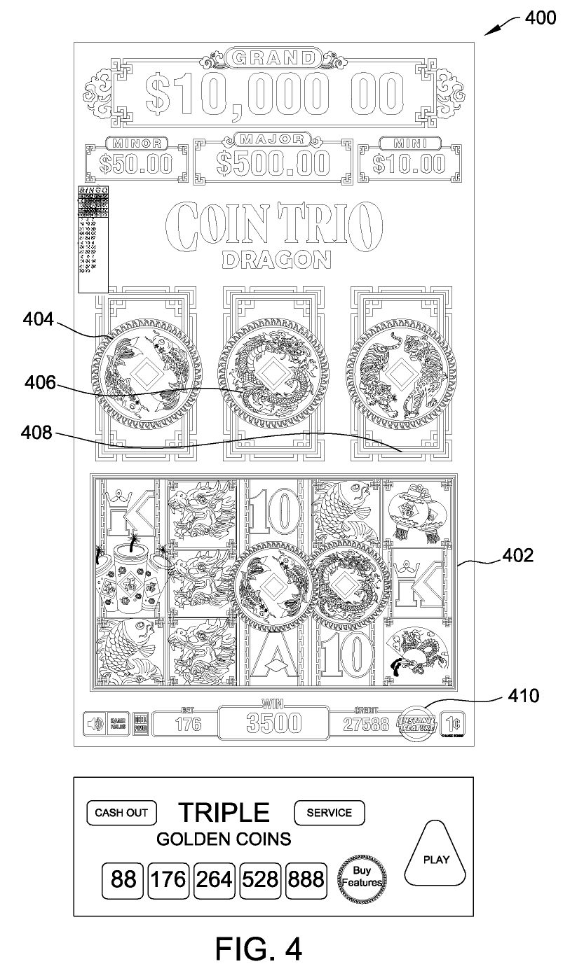

FIG. 4 illustrates an example screenshot and/or interface 400 of a base bingo game including an instant feature that may be provided, as described herein. Screenshot and/or interface 400 includes a plurality of reels 402 for displaying a base game outcome. Included in the base game outcome may be any of instant feature coins 404-408. In some embodiments, if a certain number (e.g., all three) of coins are displayed, a feature game may be triggered. In some embodiments, the feature game may be triggered based upon any certain base game outcome. However, the feature game may also be triggered in response to player selection of feature game button 410 (e.g., in some embodiments, so long as a denomination is selected).

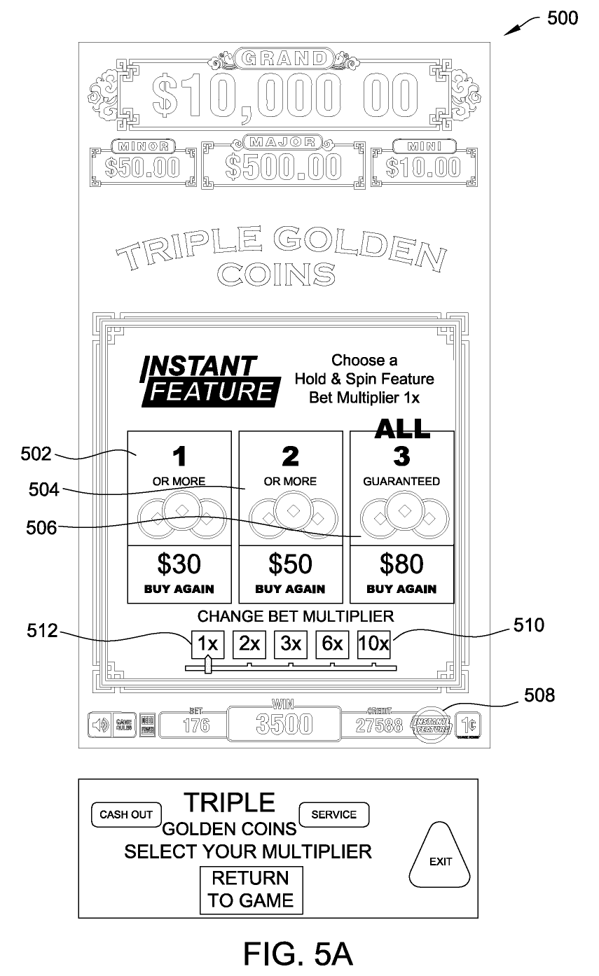

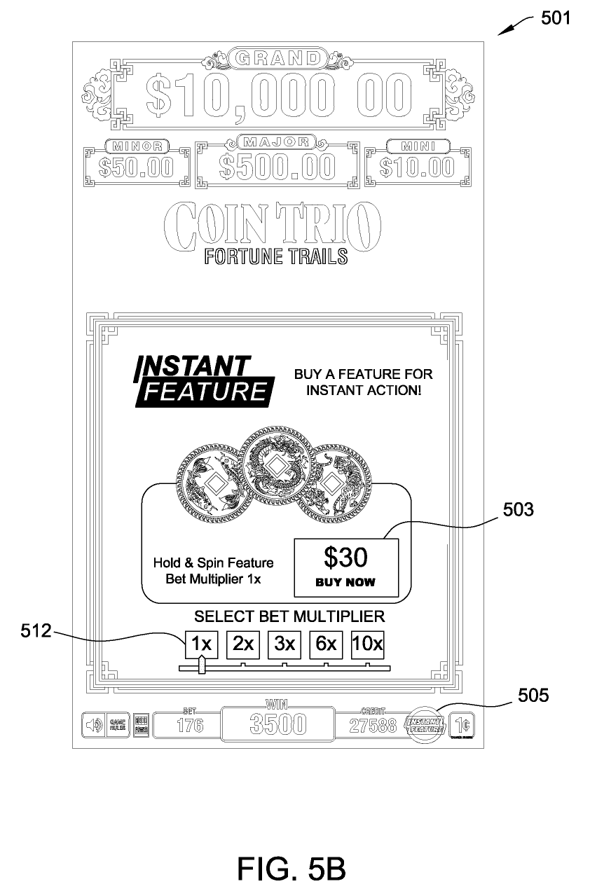

FIG. 5A illustrates an example screenshot and/or interface 500 for selecting a number of instant features in response to selection of feature game button 410 shown in FIG. 4. As described herein, a player may select a first number of instant features 502, a second number of instant features 504, or a third number of instant features 506. In example interface 500, features 502 correspond to at least one instant feature, features 504 correspond to at least two instant features, and features 506 correspond to all three instant features. In some embodiments, a random number of instant features may be provided.

If features 502 are selected, the player will be presented with at least one feature and possibly all three features in the feature game. If features 504 are selected, the player will be presented with at least two features and possibly all three features in the feature game. If features 506 are selected, the player will be presented with all three features in the feature game.

In some embodiments, features 502-506 may only be available for selection based upon a credit balance 508 in a player account associated with the player (e.g., features 502-506 not available for purchase may be greyed out/shaded or otherwise displayed differently from features 502-506 available for purchase). In some embodiments, a player may select a certain bet multiplier, from a plurality of bet multipliers 510, to be applied to the feature game. For example, interface 500 demonstrates available features 502-506 when a first multiplier 512 is selected.

FIG. 5B illustrates another example screenshot and/or interface 501 for selecting a number of instant features, as described herein. In some embodiments, including the example shown in FIG. 5B, interface 501 may provide a single option for buying at least one feature 503. For example, the player may select feature 503 (whose cost associated therewith may be determined based at least in part upon a multiplier 512 and/or wager amount). After selection of feature 503, a random number of instant features to be provided may be determined (e.g., based upon one or more RNG calls). In the example embodiment, upon selection of feature 503, any combination of the three example features described herein are determined (e.g., seven possible combinations – feature 1 only, feature 2 only, feature 3 only, features 1 and 2, etc.). In some embodiments, selection of any number of features and/or random determination of any number of features to be provided are envisioned.

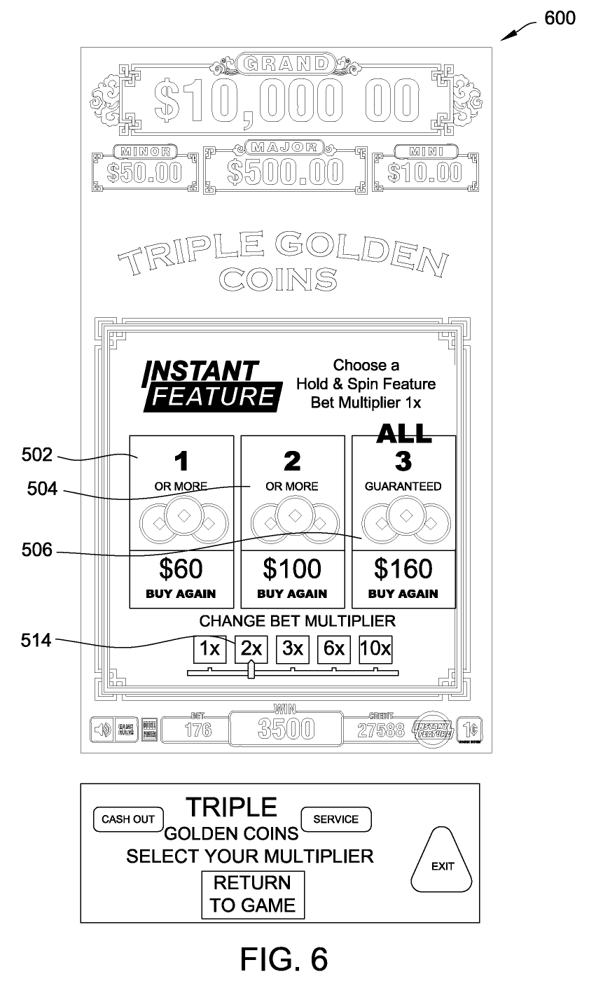

FIG. 6 illustrates another example screenshot and/or interface 600 for selecting a number of instant features, as described herein. As noted above, the cost for “buying” a feature may be determined based at least in part upon a selected multiplier amount. For example, screenshot and/or interface 600, demonstrated in FIG. 6, illustrates available features 502-506 when a second multiplier 514 is selected (e.g., the “buy now” prices of features 502-506 may scale with the multiplier selected).

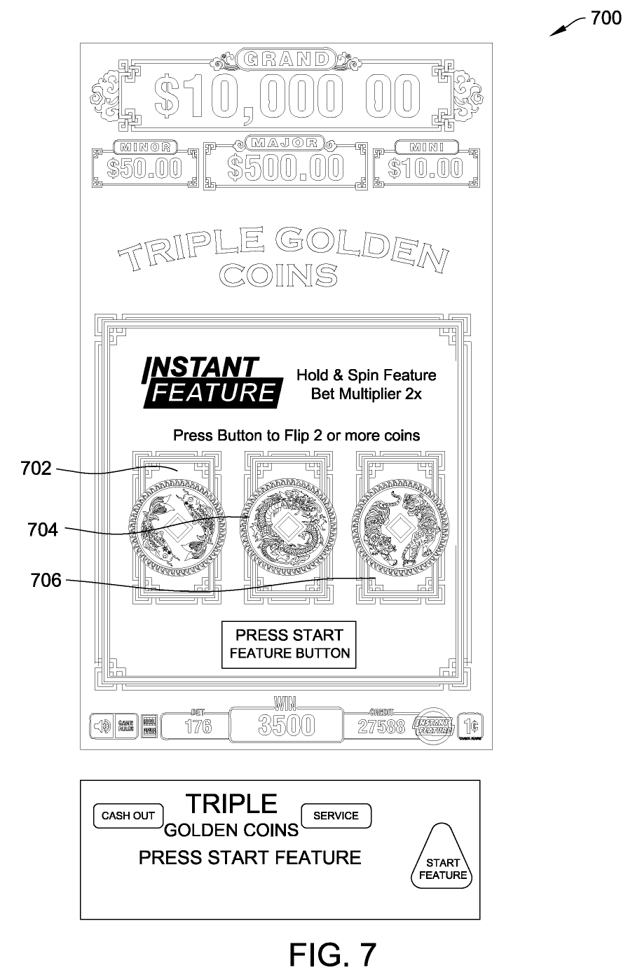

FIG. 7 illustrates an example screenshot and/or interface 700 for providing an instant feature, as described herein. In some embodiments, upon selection of a number of features 502-506, a pop-up interface may be displayed to allow the player to confirm the number of features selected. In the example embodiments, upon selection of and/or confirmation of a number of features 502-506, interface 500 transitions to an example screenshot and/or interface 700 for providing an instant feature, as shown in FIG. 7.

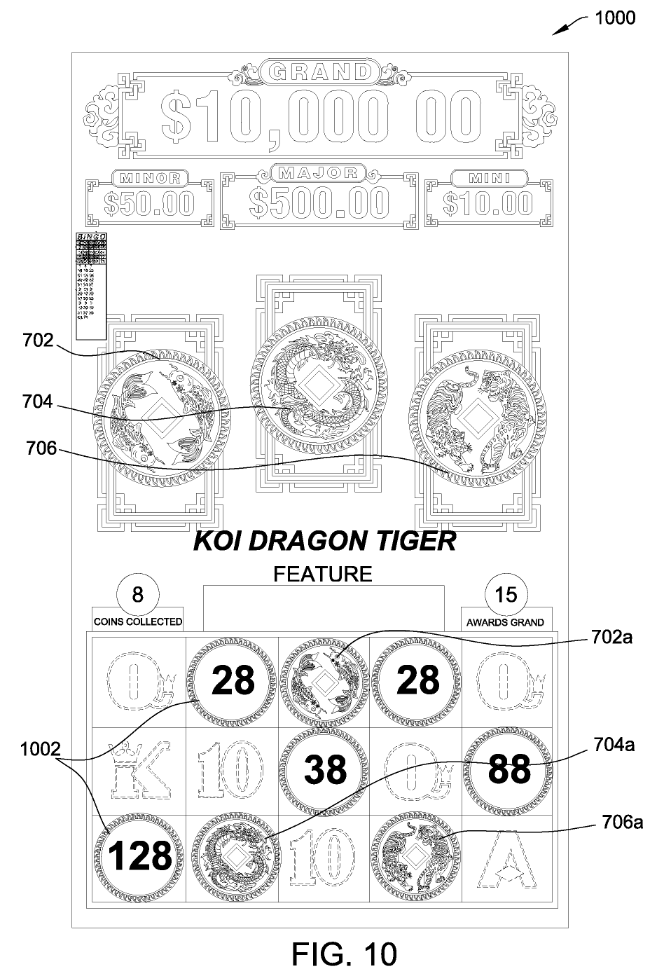

As described herein, the system may receive an input (e.g., to buy at least one feature 503) requesting play of a feature game and, based upon receiving the input, initiate the feature game. A first output from a random number generator (RNG) (e.g., RNG 319A-N) may be utilized to determine at least one instant feature of a plurality of instant features to provide in the feature game. Based upon the at least one instant feature, a table of symbols, of a plurality of tables of symbols, associated with the at least one instant feature for use in the feature game may be determined such that at least one reel position of at least one reel of a plurality of reels for the feature game is populated with at least one symbol from the table of symbols (e.g., tables 322A-N), wherein the at least one symbol is associated with the at least one instant feature (e.g., see FIG. 10).

In some embodiments, initiation of the feature game can occur regardless of the outcome of any other game (e.g., the player may buy/select the feature game and/or trigger the feature game from a base game or any other game). A number of instant features to provide in the feature game may be randomly determined (e.g., based upon an RNG output) from a plurality of instant features and at least one instant feature may be randomly determined wherein the at least one instant feature includes one instant feature for each of the number of instant features. In some embodiments, the plurality of instant features includes a first instant feature including a credit value (e.g., koi/blue), a second instant feature includes a multiplier to be applied to all displayed credit values (e.g., dragon/red), and a third instant feature includes a summation of all displayed credit values (e.g., tiger/green).

In some embodiments, an order in which to present the at least one instant feature that results in the highest output with respect to at least one other order may be determined and display of the feature game including presentation of the at least one instant feature in the order may be controlled (e.g., in a facade).

Screenshot and/or interface 700 includes coins 702-706 (e.g., corresponding to coins 404-408) each corresponding to a feature in a feature game. In the example embodiment, a number of features to be presented is determined (e.g., based upon a player selection and a random determination if less than all three features were selected). If less than all three features are determined to be presented, which of the three features to be presented are determined randomly.

As explained herein, in order to implement the instant feature in Class II bingo gaming, various embodiments are envisioned. For instance, in an example embodiment, an electronic gaming system is described. The electronic gaming system includes a first electronic gaming device configured to provide a base play of a base mode of an electronic game based upon a first input received at the first electronic gaming device and a second electronic gaming device configured to provide an instant feature play of a feature mode of the electronic game based upon a second input received at the second electronic gaming device. The electronic gaming system also includes at least one memory with instructions stored thereon and at least one processor in communication with the at least one memory. The instructions, when executed by the at least one processor, cause the at least one processor to transmit a first portion of a ball call (e.g., the first forty bingo balls) to the first electronic gaming device and the second electronic gaming device wherein the first electronic gaming device is configured to analyze the first portion of the ball call against a first bingo card to provide an output for the base play and transmit a second portion of the ball call (e.g., the next twelve bingo balls) to the second electronic gaming device wherein the second electronic gaming device is configured to analyze the first portion of the ball call and the second portion of the ball call (e.g., fifty-two balls total) against a second bingo card to provide an output for the instant feature play and wherein the second electronic gaming device is configured to cause display of an animation between receiving the first portion of the ball call and the second portion of the ball call (e.g., during a lag period when the second electronic gaming device waits for the additional twelve bingo balls for the instant feature game).

In another example embodiment, an electronic gaming system including at least one memory with instructions stored thereon and at least one processor in communication with the at least one memory is described. The instructions, when executed by the at least one processor, cause the at least one processor to receive a first input from a first electronic gaming device, the first input being associated with a base play of a base mode of an electronic game at the first electronic gaming device, and receive a second input from a second electronic gaming device, the second input being associated with an instant feature play of a feature mode of the electronic game at the second electronic gaming device. The instructions also cause the at least one processor to generate a ball call for the electronic game. The instructions further cause the at least one processor to transmit a first portion of the ball call (e.g., forty balls for the base game) to the first electronic gaming device based upon the first input being associated with the base play and transmit a second portion of the ball call (e.g., fifty-two balls to guarantee that the instant feature game is triggered because the instant feature was selected) to the second electronic gaming device based upon the second input being associated with the instant feature play.

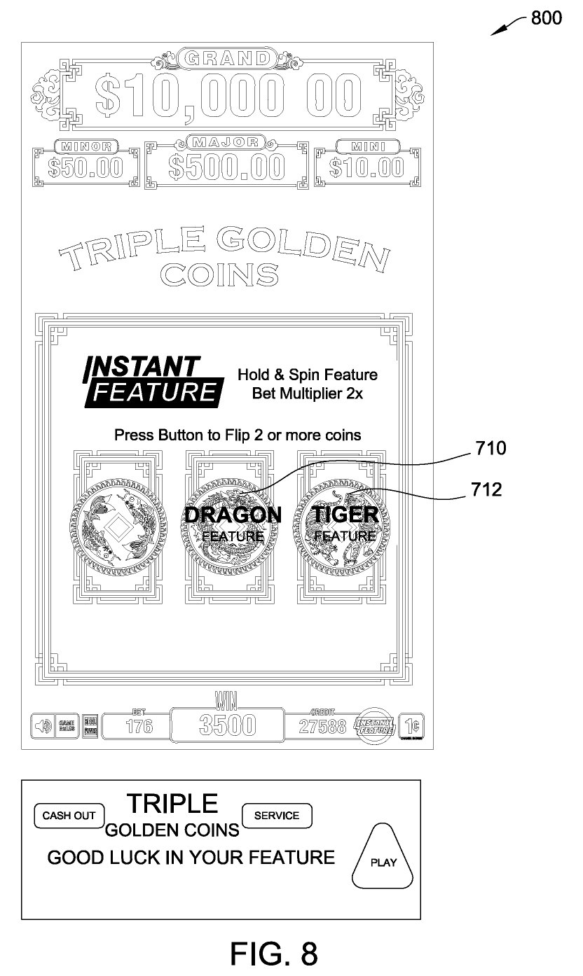

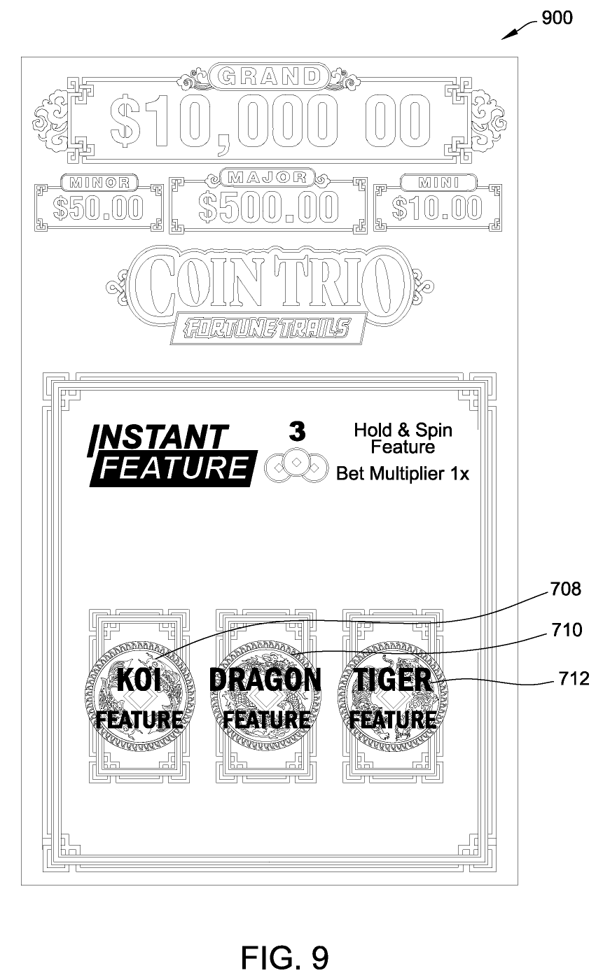

FIG. 8 illustrates an example screenshot and/or interface 800 demonstrating features provided from the interface shown in FIG. 7. In screenshot and/or interface 800 it is indicated that a “dragon”/red feature 710 and a “tiger”/green feature 712 will be presented while in screenshot and/or interface 900 of FIG. 9 it is indicated that a “koi”/blue feature 708, the “dragon” feature 710, and the “tiger” feature 712 will be presented. In the example embodiment, the “koi” feature 708 corresponds to a symbol in the feature game corresponding to a high credit value (e.g., determined randomly and higher than other credit values displayed on the reels), “dragon” feature 710 corresponds to a multiplier feature that causes all displayed credit values to be multiplied by a certain amount, and “tiger” feature 712 corresponds to a symbol corresponding to the sum of all other credit values displayed on the reels. In some embodiments, any features (e.g., corresponding to any game enhancements such as multipliers, credit values, etc.) corresponding to any number of coins and/or other images/animations may be provided. The coins and features associated therewith described herein illustrate an example embodiment while other embodiments including any number of features and/or images/animations are envisioned.

FIG. 9 illustrates another example screenshot and/or interface 900 demonstrating features provided from the interface shown in FIG. 7. In some embodiments, before the feature game is presented (e.g., as shown in FIG. 10), a base game outcome (e.g., a losing base game outcome) may be run/determined in the background and hidden from the player (e.g., for regulatory purposes). In screenshot and/or interface 1000, coins 702-706 are displayed to indicate that the features respectively associated therewith will be presented in the feature game. As also shown in screenshot and/or interface 1000, certain symbols 1002 are displayed on a plurality of reels to indicate credit values to be presented to the player at the end of the feature game (e.g., COR (cash on reel) symbols or cash on reels symbols). Further, coins 702a-706a are displayed on the plurality of reels and correspond to coins 702-706. In the example embodiment, the displayed credit values remain in place while each other symbol position is spun as its own reel during each spin (e.g., wherein each reel may include at least one symbol corresponding to a lookup table associated with feature(s) provided in the feature game, as described herein). If a new COR is displayed at a symbol position previously not including a COR, the new COR remains stationary for remaining spins and the number of spins available to the player is reset.

For example, a player may be presented with three spins at the beginning of the feature game. During each spin, each symbol position/reel not including a COR is spun. If a new COR is displayed, the number of spins is reset to three. If a new COR is not displayed, the number of spins is decremented by one. The feature game ends when either zero spins remain or each symbol position includes a COR symbol.

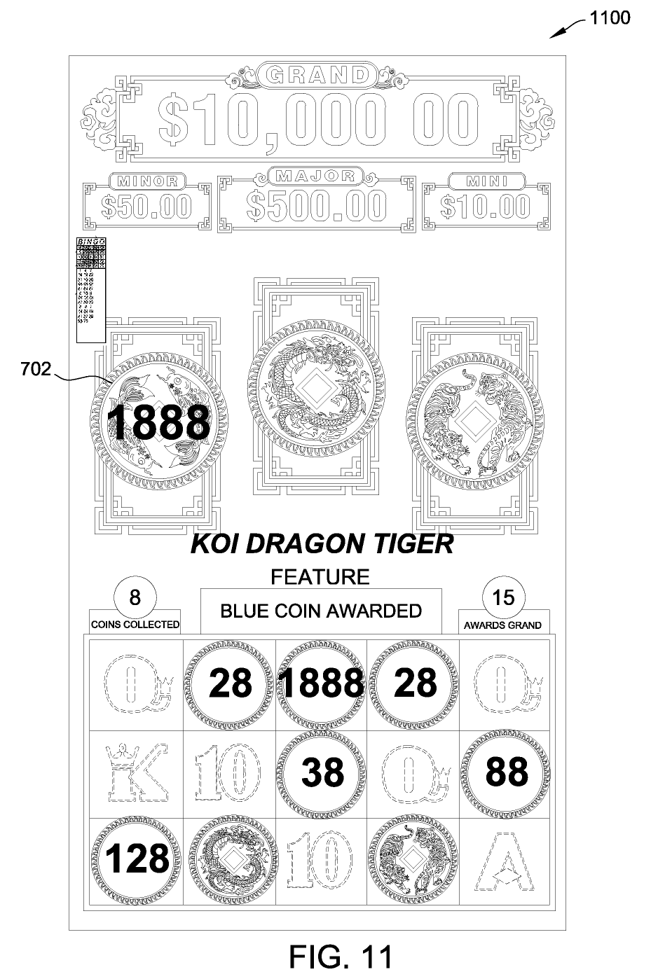

FIG. 11 illustrates an example screenshot and/or interface 1100 of the example feature bingo game shown in FIG. 10 after an instant feature shown in FIG. 9 has been provided. In the example embodiment, coin 702 corresponds to a large output amount/credit value. When coin 702 is displayed during the feature game, coin 702 may “flip” over any number of times, displaying an increased credit amount with each flip, until coin 702 stops flipping and a final credit amount is displayed (e.g., on coins 702, 702a). For example, before arriving at a credit value of 1888 as shown in FIG. 11, coin 702 above may flip any number of times, displaying an increased credit value with each flip, until 1888 is displayed as the final credit amount (e.g., at coins 702 and the symbol position previously displaying coin 702a) in order to increase player anticipation and/or excitement. In some embodiments, when this “blue” or Koi feature is determined to be provided, and the system determines to present a jackpot amount (e.g., MINI, MINOR, MAJOR, GRAND, etc.), the system may control the jackpot amount to be presented as a blue coin as opposed to another COR (e.g., to increase player excitement). In some embodiments, only certain jackpots (e.g., MAJOR) may be determined to be presented as a blue/Koi feature (e.g., because the MAJOR jackpot is a more valuable jackpot than MINOR or MINI, as examples).

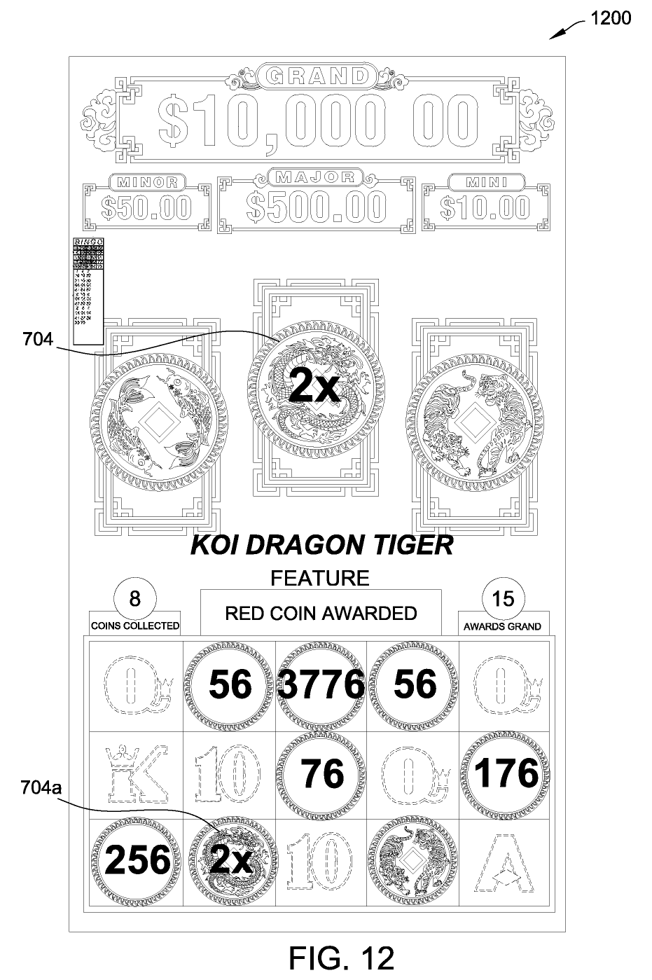

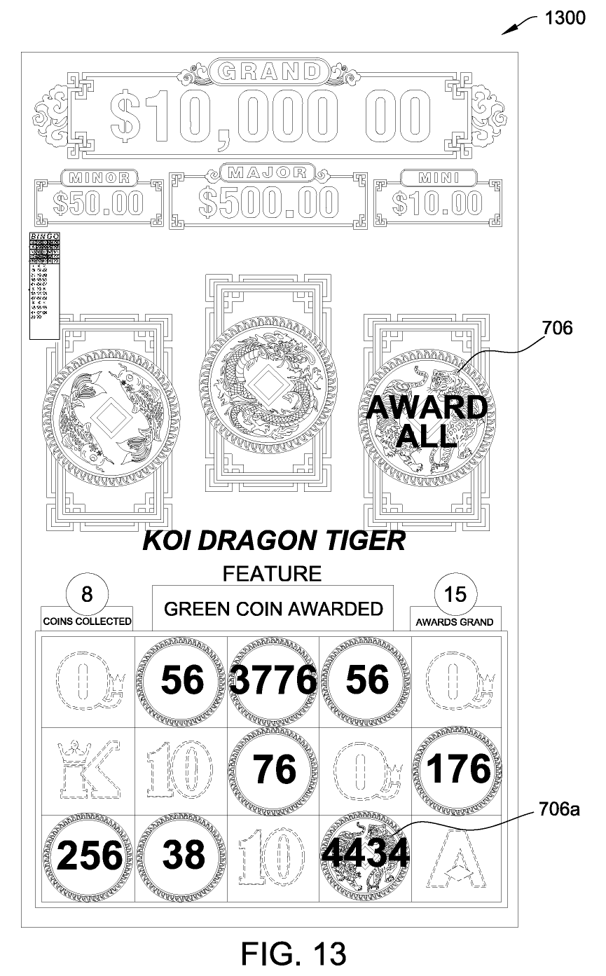

FIG. 12 illustrates an example screenshot and/or interface 1200 of the example feature bingo game shown in FIG. 10 after another instant feature shown in FIG. 9 has been provided. In the example embodiment, coin 704 corresponds to a multiplier causing all other CORs to be multiplied. For example, in FIG. 12 coins 704, 704b correspond to a multiplier of two. Accordingly, each COR from FIG. 11 is multiplied by two in FIG. 12. After the multiplier is applied, the symbol position previously including coin 704a may replace coin 704a with a random credit amount, as shown in FIG. 13.

FIG. 13 illustrates an example screenshot and/or interface 1300 of the example feature bingo game shown in FIG. 10 after another instant feature shown in FIG. 9 has been provided. In the example embodiment, coin 706 corresponds to a sum of all CORs displayed in FIG. 12 (e.g., AWARD ALL). Accordingly, all CORs are added and the resulting sum, 4434 credits, is displayed as a COR at coin 706a.

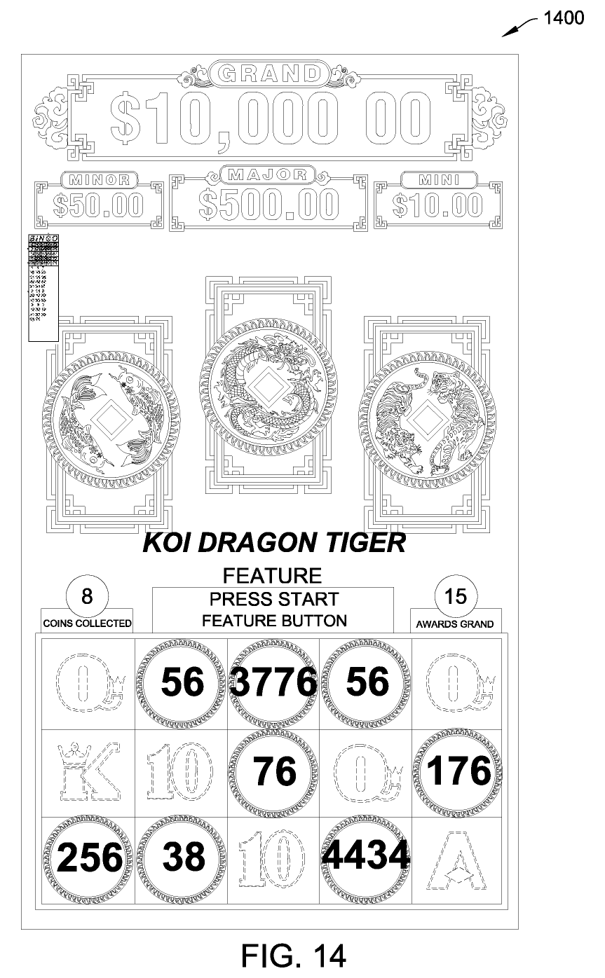

FIG. 14 illustrates an example screenshot and/or interface 1400 of the example feature bingo game shown in FIG. 10 after all of the instant features shown in FIG. 9 have been provided. Accordingly, coins 702a-706c have been replaced by CORs as described above in greater detail. As the feature game progresses (e.g., with each spin of the individual reels not already including a COR as described above), additional coins 702a-706a may be presented at symbol positions not previously including a COR. Accordingly, if an additional coin 702a-706a is presented, the same feature associated with the previously presented coins 702a-706a may be presented (e.g., a blue coin corresponding to the Koi feature may have a value of 1888 credits (e.g., as shown in FIG. 11) or a new/different value, a red coin corresponding to the Dragon feature may apply another 2x multiplier to all CORs or a different multiplier, and a green coin corresponding to the Tiger feature may have a value of 4434 credits or may include a new summation including any currently-displayed credit amounts).

In some embodiments, features may be applied in an order determined to result in the highest output to the player. For example, the feature associated with coin 702 may be presented before the feature associated with coins 704 and/or 706 such that the features associated with coins 704 and 706 (multiplication and summation respectively) will be applied to the high credit value associated with coin 702. In some embodiments, features (e.g., the number of features, the credit value/game enhancement associated with the features) may be determined based at least upon a target return to player (e.g., RTP, as described herein).

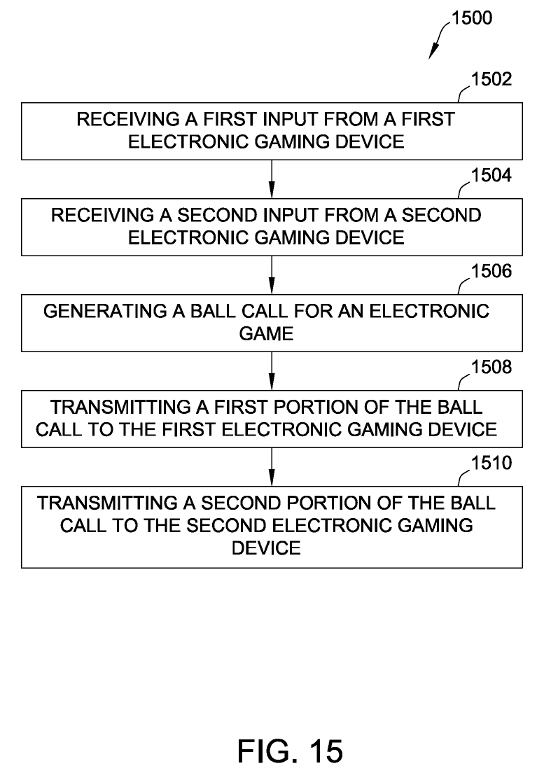

FIG. 15 illustrates an example method 1500 for electronic bingo gaming with one or more instant features, in accordance with the present disclosure.

As shown in FIG. 15, method 1500 includes receiving 1502 a first input from a first electronic gaming device, the first input being associated with a base play of a base mode of an electronic game at the first electronic gaming device, and receiving 1504 a second input from a second electronic gaming device, the second input being associated with an instant feature play of a feature mode of the electronic game at the second electronic gaming device. Method 1500 also includes generating 1506 a ball call for the electronic game, transmitting 1508 a first portion of the ball call to the first electronic gaming device based upon the first input being associated with the base play, and transmitting 1510 a second portion of the ball call to the second electronic gaming device based upon the second input being associated with the instant feature play.

In some embodiments of method 1500, the first portion of the ball call includes forty balls. In some embodiments of method 1500, the second portion of the ball call includes fifty-two balls.

In some embodiments of method 1500, the second input is transmitted from the second electronic gaming device based upon a player selecting to trigger the instant feature play at the second electronic gaming device. In some embodiments of method 1500, the second electronic gaming device bypasses play of the base mode and enters the feature mode upon the player selecting to trigger the instant feature play.

In some embodiments of method 1500, the first electronic gaming device analyzes the first portion of the ball call against a first bingo card to determine an outcome for the base play wherein the second electronic gaming device analyzes the second portion of the ball call against a second bingo card to determine an outcome for the instant feature play. In some embodiments of method 1500, the first electronic gaming device causes the feature mode to be entered based upon analyzing the first portion of the ball call against the first bingo card.

In some embodiments, method 1500 also includes determining that the second input is associated with the feature mode based upon the second input including a flag indicating that the instant feature play of the feature mode has been selected at the second electronic gaming device.

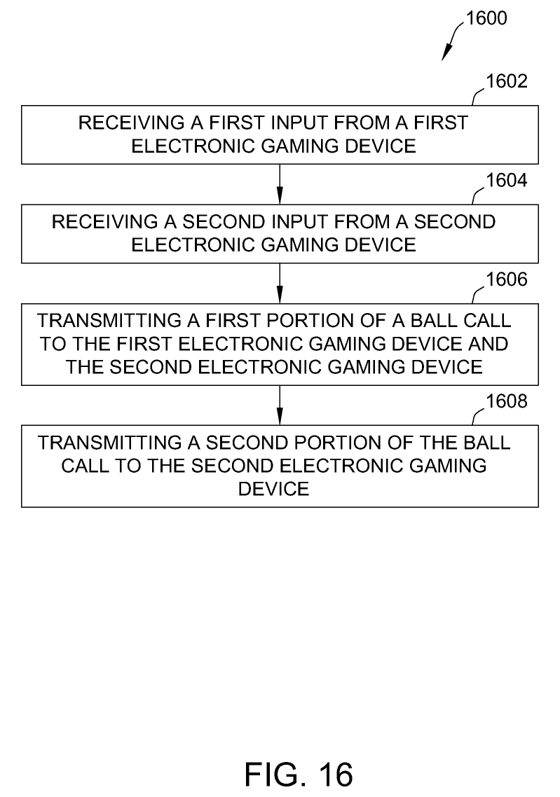

FIG. 16 illustrates another example method 1600 for electronic bingo gaming with one or more instant features, in accordance with the present disclosure.

In the example embodiment, method 1600 is implemented by at least one processor in communication with at least one memory.

As shown in FIG. 16, method 1600 includes receiving 1602 a first input from a first electronic gaming device, the first input indicating that a base play of a base mode of an electronic game has been initiated at the first electronic gaming device. Method 1600 also includes receiving 1604 a second input from a second electronic gaming device, the second input indicating that an instant feature play of a feature mode of the electronic game has been initiated at the second electronic gaming device. Method 1600 further includes transmitting 1606 a first portion of a ball call to the first electronic gaming device and the second electronic gaming device wherein the first electronic gaming device is configured to analyze the first portion of the ball call against a first bingo card to provide an output for the base play. Method 1600 yet further includes transmitting 1608 a second portion of the ball call to the second electronic gaming device wherein the second electronic gaming device is configured to analyze the first portion of the ball call and the second portion of the ball call against a second bingo card to provide an output for the instant feature play and wherein the second electronic gaming device is configured to cause display of an animation between receiving the first portion of the ball call and the second portion of the ball call.

In some embodiments, method 1600 also includes transmitting the second portion of the ball call to the second electronic gaming device and not to the first electronic gaming device.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a first electronic gaming device configured to provide a base play of a base mode of an electronic game based upon a first input received at the first electronic gaming device;
a second electronic gaming device configured to provide an instant feature play of a feature mode of the electronic game based upon a second input received at the second electronic gaming device;
at least one memory with instructions stored thereon; and
at least one processor in communication with the at least one memory, wherein the instructions, when executed by the at least one processor, cause the at least one processor to:
transmit a first portion of a ball call to the first electronic gaming device and the second electronic gaming device, wherein the first electronic gaming device is configured to analyze the first portion of the ball call against a first bingo card to provide an output for the base play; and
transmit a second portion of the ball call to the second electronic gaming device, wherein the second electronic gaming device is configured to analyze the first portion of the ball call and the second portion of the ball call against a second bingo card to provide an output for the instant feature play, and wherein the second electronic gaming device is configured to cause display of an animation between receiving the first portion of the ball call and the second portion of the ball call.

2. The electronic gaming system of claim 1, wherein the first portion comprises a first number of balls of the ball call.

3. The electronic gaming system of claim 2, wherein the first portion and the second portion comprise a total of a second number of balls of the ball call, the second number being greater than the first number, and the second number of balls comprising the first number of balls.

4. The electronic gaming system of claim 3, wherein the second number of balls is configured to be associated with an outcome that guarantees that the feature mode will be entered at the second electronic gaming device instead of the base mode.

5. The electronic gaming system of claim 1, wherein the first electronic gaming device is configured to analyze the first portion of the ball call against the first bingo card and a first set of paytables.

6. The electronic gaming system of claim 5, wherein the second electronic gaming device is configured to analyze the first portion of the ball call and the second portion of the ball call against the second bingo card and a second set of paytables.

7. The electronic gaming system of claim 6, wherein the first set of paytables comprises a first set of bingo patterns, and wherein the second set of paytables comprises a second set of bingo patterns.

8. The electronic gaming system of claim 1, wherein the instructions further cause the at least one processor to transmit the second portion of the ball call to the second electronic gaming device and not to the first electronic gaming device.

9. The electronic gaming system of claim 1, wherein the instructions further cause the at least one processor to transmit the first portion of the ball call and the second portion of the ball call to a third electronic gaming device configured to provide another instant feature play of the feature mode of the electronic game based upon a third input received at the third electronic gaming device.

10. At least one non-transitory computer-readable storage medium with instructions stored thereon that, in response to execution by at least one processor, cause the at least one processor to:
receive a first input from a first electronic gaming device, the first input indicating that a base play of a base mode of an electronic game has been initiated at the first electronic gaming device;
receive a second input from a second electronic gaming device, the second input indicating that an instant feature play of a feature mode of the electronic game has been initiated at the second electronic gaming device;
transmit a first portion of a ball call to the first electronic gaming device and the second electronic gaming device, wherein the first electronic gaming device is configured to analyze the first portion of the ball call against a first bingo card to provide an output for the base play; and
transmit a second portion of the ball call to the second electronic gaming device, wherein the second electronic gaming device is configured to analyze the first portion of the ball call and the second portion of the ball call against a second bingo card to provide an output for the instant feature play, and wherein the second electronic gaming device is configured to cause display of an animation between receiving the first portion of the ball call and the second portion of the ball call.

11. The at least one non-transitory computer-readable storage medium of claim 10, wherein the first portion comprises a first number of balls of the ball call.

12. The at least one non-transitory computer-readable storage medium of claim 11, wherein the first portion and the second portion comprise a total of a second number of balls of the ball call, the second number being greater than the first number, and the second number of balls comprising the first number of balls.

13. The at least one non-transitory computer-readable storage medium of claim 12, wherein the second number of balls is configured to be associated with an outcome that guarantees that the feature mode will be entered at the second electronic gaming device instead of the base mode.

14. The at least one non-transitory computer-readable storage medium of claim 10, wherein the first electronic gaming device is configured to analyze the first portion of the ball call against the first bingo card and a first set of paytables.

15. The at least one non-transitory computer-readable storage medium of claim 14, wherein the second electronic gaming device is configured to analyze the first portion of the ball call and the second portion of the ball call against the second bingo card and a second set of paytables.

16. The at least one non-transitory computer-readable storage medium of claim 15, wherein the first set of paytables comprises a first set of bingo patterns, and wherein the second set of paytables comprises a second set of bingo patterns.

17. The at least one non-transitory computer-readable storage medium of claim 10, wherein the instructions further cause the at least one processor to transmit the second portion of the ball call to the second electronic gaming device and not to the first electronic gaming device.

18. The at least one non-transitory computer-readable storage medium of claim 10, wherein the instructions further cause the at least one processor to transmit the first portion of the ball call and the second portion of the ball call to a third electronic gaming device configured to provide another instant feature play of the feature mode of the electronic game based upon a third input received at the third electronic gaming device.

19. A method of electronic gaming implemented by at least one processor in communication with at least one memory, the method comprising:
receiving a first input from a first electronic gaming device, the first input indicating that a base play of a base mode of an electronic game has been initiated at the first electronic gaming device;
receiving a second input from a second electronic gaming device, the second input indicating that an instant feature play of a feature mode of the electronic game has been initiated at the second electronic gaming device;
transmitting a first portion of a ball call to the first electronic gaming device and the second electronic gaming device, wherein the first electronic gaming device is configured to analyze the first portion of the ball call against a first bingo card to provide an output for the base play; and
transmitting a second portion of the ball call to the second electronic gaming device, wherein the second electronic gaming device is configured to analyze the first portion of the ball call and the second portion of the ball call against a second bingo card to provide an output for the instant feature play, and wherein the second electronic gaming device is configured to cause display of an animation between receiving the first portion of the ball call and the second portion of the ball call.

20. The method of claim 19, further comprising transmitting the second portion of the ball call to the second electronic gaming device and not to the first electronic gaming device.
